(19) United States
(12) Patent Application Publication
(10) Pub. No.: US 2024/0330650 A1
(43) Pub. Date: Oct. 3, 2024

(54) SCALABLE EVOLVING INCEPTION GRAPH NEURAL NETWORKS FOR DYNAMIC GRAPHS

(71) Applicant: International Business Machines Corporation, Armonk, NY (US)

(72) Inventors: Xiao Qin, San Jose, CA (US); Nasrullah Sheikh, San Jose, CA (US); Berthold Reinwald, San Jose, CA (US)

(21) Appl. No.: 18/191,233

(22) Filed: Mar. 28, 2023

(51) Int. Cl. G06N 3/044

(52) U.S. Cl. CPC G06N 3/044

(57) ABSTRACT

Aspects include techniques for predicting system behaviors using a trained machine learning model. Aspects include receiving a sequence of snapshots of DTDGs, each including a plurality of nodes and generating node embeddings and transformation weight matrices for each of the plurality of nodes using a multi-hop parameter-free message passing operation. Aspects also include applying graph filters for each snapshot based on the plurality of node embeddings and a plurality of weight matrices for each of the plurality of nodes of the snapshot and concatenating the graph filters for each of the sequence of snapshots to create a final graph embedding for each snapshot. Aspects further include processing, by a self-attention layer, the final graph embedding for each snapshot as a sequence, a final embedding for each node and predicting a node value for a node of a next DTDG according to the final embedding for each node.

### BACKGROUND

The present invention generally relates to graph neural networks (GNNs), and more specifically, to computer systems, computer-implemented methods, and computer program products for scalable evolving GNNs for dynamic graphs.

Modern data are relational in nature with dynamic interactions between entities and complex dependency structures. Constantly evolving social networks, temporal user-item relationships in e-commerce, and dynamic financial transactions are only a few examples of the data naturally being represented in the form of dynamic graphs. The ability to extract insights from such evolving relational data provides enterprises with a competitive advantage. For example, an IT procurement graph integrates buyer and seller's entities through various types of purchase related relations such as maintenance contracts, technical support agreements and equipment purchases. The relationships evolve constantly depending on the buyers' financial planning, strategic priorities, and sellers' offerings. Being able to extract insights from these changes allows companies to make timely and strategic recommendations.

Graph neural networks (GNNs) have accomplished great success in learning complex systems of relations arising in broad problem settings ranging from e-commerce, social networks to computational biology. However, modern relational data is constantly evolving, which creates an additional layer of learning challenges. Recently, message-passing based GNNs for dynamic graphs have attracted considerable attention. Message passing-based GNNs adopt a neighborhood aggregation strategy where the representation of a node is generated by iteratively aggregating representations of its neighbors. To capture the dynamic patterns of the graphs, sequence models, e.g., recurrent neural networks (RNNs) and self-attention network are introduced for these GNN models. In the context of discrete-time dynamic graphs (DTDGs), most existing approaches use temporal information of graph changes to regulate the graph representations over time. Graph convolutional networks (GCN) have been used to generate the embeddings for nodes in every snapshot and feed them to a long short-term memory (LSTM) to model the changing dynamics. Similarly, graph attention networks, like architecture for the snapshots, have been used to model the node sequences. While achieving promising results on smaller graphs, there are limitations to these approaches.

### SUMMARY

Embodiments of the present invention are directed to techniques for predicting system behaviors using a trained machine learning model. A non-limiting example method includes receiving a sequence of snapshots of discrete-time dynamic graphs (DTDGs), each snapshot including plurality of nodes and generating a plurality of node embeddings and a plurality of transformation weight matrices for each of the plurality of nodes using a multi-hop parameter-free message passing operation. The method also includes applying graph filters for each snapshot based on the plurality of node embeddings and a plurality of weight matrices for each of the plurality of nodes of the snapshot and concatenating the graph filters for each of the sequence of snapshots to create a final graph embedding for each snapshot. The method further includes processing, by a self-attention layer, the final graph embedding for each snapshot as a sequence, a final embedding for each node and predicting a node value for a node of a next DTDG according to the final embedding for each node.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a series of snapshots of discrete-time dynamic graphs (DTDGs) in accordance with one or more embodiments of the present invention;

FIG. 3 depicts a schematic diagram of a system for generating an embedding for a node for a sequence of dynamic graphs in accordance with one or more embodiments of the present invention;

FIG. 4 depicts a message passing algorithm used in system for generating an embedding for a node for a sequence of dynamic graphs in accordance with one or more embodiments of the present invention;

FIG. 5 depicts an algorithm for evolving filters used in system for generating an embedding for a node for a sequence of dynamic graphs in accordance with one or more embodiments of the present invention;

FIG. 6 depicts an algorithm for top-k pooling used in system for generating an embedding for a node for a sequence of dynamic graphs in accordance with one or more embodiments of the present invention;

FIG. 7 depicts an algorithm for self-attention used in system for generating an embedding for a node for a sequence of dynamic graphs in accordance with one or more embodiments of the present invention;

FIG. 8 depicts a mini-batch of a sequence of dynamic graphs in accordance with one or more embodiments of the present invention; and

FIG. 9 is a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

Disclosed herein is a scalable evolving inception GNN for representation learning on DTDGs that addresses the above-described challenges, with emphasis on the resource efficiency. The disclosed methods utilize a lightweight GNN that achieves high expressive power without relying on compute-intensive and data-intensive operations over large-scale dynamic graphs.

In exemplary embodiments, the graph model (parameters) and the graph representation (embeddings) are to simultaneously evolved to tailor the GNN to each snapshot in the sequence of DTDGs. A gated recurrent unit (GRU) is used to regulate the weight matrices of the GNN. Specifically, a model evolving module takes a previous weight matrix as the hidden states and a graph summary as inputs, and outputs a new weight matrix which is used for generating the embeddings for the new snapshot. In exemplary embodiments, top-k pooling is to generate the graph summary of the new snapshot which has the same dimension of the weight matrix. The embedding sequence is evolved using a self-attention network to generate the final embedding for the downstream tasks.

In exemplary embodiments, the scalability and the compute resource challenges are addressed by partially moving node dependencies to a one-time offline preprocessing step. In one embodiment, message passing is performed based on a set of predefined linear diffusion operations, that each correspond to a k-hop message passing process that is similar to the effect of stacking k GCN layers. Since there are no trainable parameters involved during the diffusion process, the node dependencies within a snapshot are removed which reduces the training memory footprint and makes it easy to construct mini-batches. Each operator is equipped with a node-wise transformation matrix towards the end, together called a graph filter. The embeddings for a snapshot are generated based on a set of graph filters covering multiple neighborhood sizes. In exemplary embodiments, an evolving graph filter is created by extending the model evolving design to adjust the filter parameters to better fit different snapshots.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

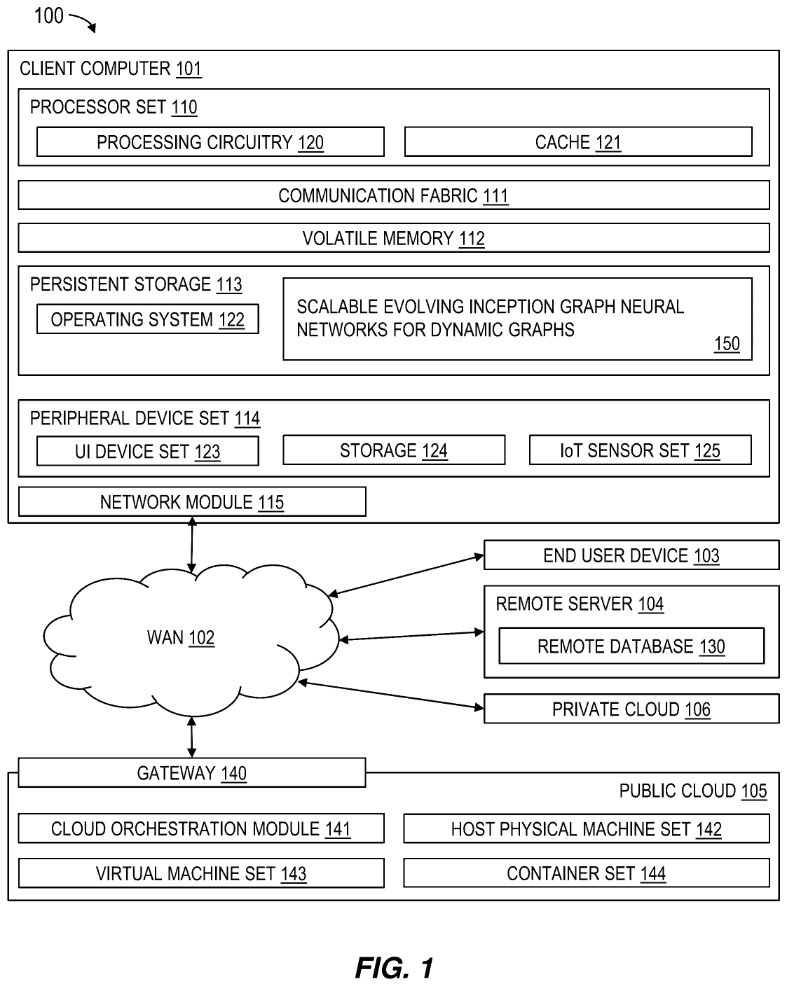

Referring now to FIG. 1, computing environment 100 contains an example of an environment for the execution of at least some of the computer code involved in performing the inventive methods, such as scalable evolving inception graph neural networks for dynamic graphs 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The model of discrete-time dynamic graphs (DTDGs) is widely adopted by many applications to capture the evolving nature of a dynamic graph. DTDGs are sequences of graph snapshots taken at time intervals that explicitly model the insertions, deletions, and updates of the graph at discrete times. Typically, the objective is to learn the node and graph representations for the newest snapshot by taking into consideration the historical snapshots, commonly referred to as the extrapolation problem with the consideration of efficient model training.

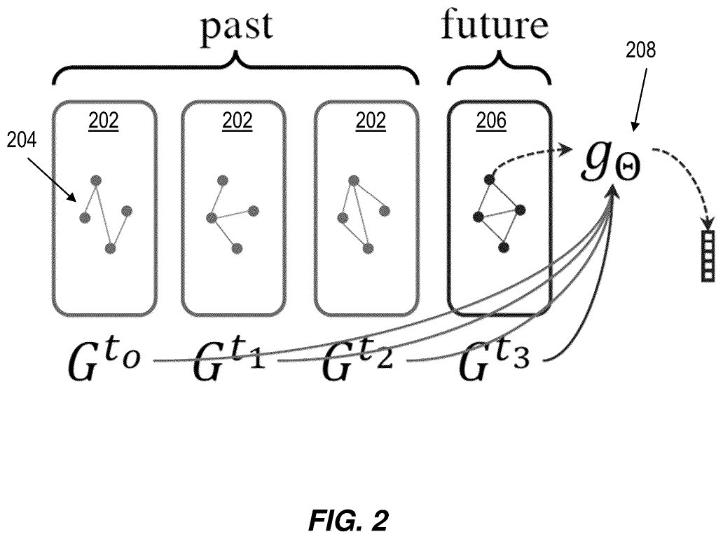

FIG. 2 depicts a series of snapshots of discrete-time dynamic graphs (DTDGs) in accordance with one or more embodiments of the present invention. More specifically, FIG. 2 depicts a series of snapshots 202 that each include a graph 204 that represents a discrete time period in the past and one snapshot 206 that includes a predicted graph that represents a future time period.

Let [symbol] =( [symbol] , ε, χ) denote a static graph. [symbol] ={v₁, . . . , v_{|v|}} is a set of nodes in [symbol] . ε⊆ [symbol] × [symbol] is a set of edges where eₖ=(vᵢ, vⱼ)∈ε indicates an undirected edge between node vᵢ and vⱼ. χ is the initial node feature matrix and xᵢ denotes the initial node feature vector of node vᵢ. Let [symbol] ={t₁, . . . , [symbol] } denote a set of discrete times, countably infinite, over which a linear order [symbol] is defined, where tᵢ [symbol] tⱼ means tᵢ occurs strictly before tⱼ. Extending from the static graph definition, a DTDG [symbol] ={ [symbol] ^{t}^{₁}, . . . , [symbol] } is defined as a sequence of static graphs, also called snapshots, where [symbol] ^{t}^{ᵢ}=(V^{t}^{ᵢ}, ε^{t}^{ᵢ}, χ^{t}^{ᵢ}).

TABLE I
A LIST OF NOTATIONS.

| Symbol | Description |
|---|---|
| tᵢ | A timestamp |
| [symbol] _{^{t}}ⁱ | A graph snapshot at time tᵢ |
| ν_{^{t}}ⁱ | The node set of [symbol] _{^{t}}ⁱ |
| ε_{^{t}}ⁱ | The edge set of [symbol] _{^{t}}ⁱ |
| [symbol] _{^{t}}ⁱ | The initial node feature matrix of [symbol] _{^{t}}ⁱ |
| [symbol] ^{T} | A sequence of graph snapshots, i.e., a DTDG |
| Θ | A set of trainable parameters |
| gΘ | An embedding function parameterized by Θ |
| [symbol] _{^{t}}ⁱ | A set of linear diffusion operators for [symbol] _{^{t}}ⁱ |
| [symbol] _{^{t}}ⁱ | The node embedding matrix of [symbol] _{^{t}}ⁱ |
| [symbol] ′ | The node embedding matrix of the future |
| | snapshot of [symbol] ^{T} |

In exemplary embodiments, methods and systems are provided that are configured to learn the node level representations for a sequence of DTDGs in order to make predictions for time [symbol] . In order to make these predictions, a function g_{Θ} 208 parameterized by Θ is learned that maps a node v∈ [symbol] to a lower dimensional space given [symbol] . For example, as shown in FIG. 2, g_{Θ} 208 computes the embeddings for nodes in [symbol] ^{t}^{₃} based on the nodes and edges in { [symbol] ^{t}^{₀}, [symbol] ^{t}^{₁}, [symbol] ^{t}^{₂}, [symbol] ^{t}^{₃}}.

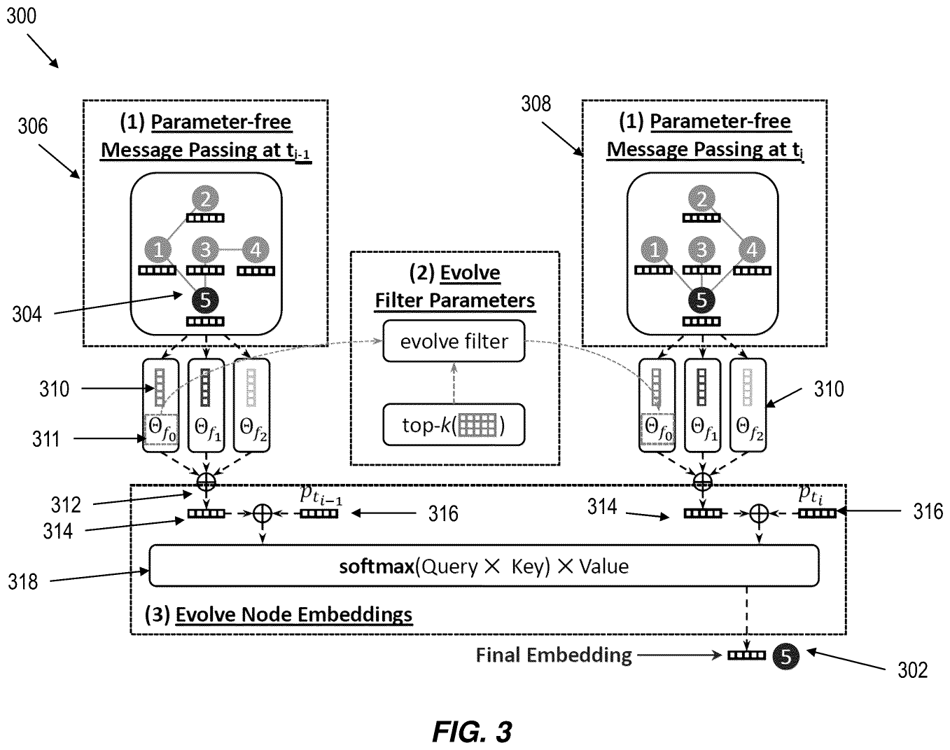

Referring now to FIG. 3, a schematic diagram of a system 300 for generating an embedding for a node for a sequence of DTDGs is shown. FIG. 3 illustrates an example of how a final embedding 302 for node v₅ 304 is generated based on one historical snapshot 306 at tᵢ₋₁ and the current snapshot 308 at tᵢ. First, v₅ 304 participates in a series of message passing activities, independently in both of the snapshots. For each snapshot, multiple embeddings 310 are generated for v₅ 304 where each embedding 310 is the result of a specific linear diffusion operation followed by a node-wise transformation. A diffusion operation, for example, may be defined as a k-hop message passing operation without any trainable parameters. In FIG. 3, where k=2, three embeddings 310 are generated for v₅ 304 corresponding to 0, 1 and 2-hop message passing operations for both snapshots 306, 308. The combination of a diffusion operation and the associated transformation weight matrix Θ_{f} is referred to herein as a graph filter 311. The embeddings resulting from applying multiple graph filters are concatenated at operation 312 to form the final graph embedding 314 for a particular snapshot. Note that although the same graph filters are used for both snapshots, the filter's parameters 316 are not shared across snapshots. For example, Θ_{f}, at tᵢ is generated based on Θ_{f}_{₀} at tᵢ₋₁ and a graph summary of the snapshot at tᵢ corresponding to the respective diffusion operation. Once v's 304 final graph embeddings 314 at tᵢ₋₁ and tᵢ are obtained, they are processed by a self-attention layer 318 as a sequence, and the output is the final embedding 302 of v₅ 304 representing the evolution of the node embeddings of v₅.

In general, message passing-based GNNs use a recursive neighborhood aggregation scheme, where within a single GNN layer, each node aggregates its neighbors' messages and use the aggregated messages to update its own state. The transformation, aggregation and update of the messages are usually parameterized which requires large amounts of storage for memorizing all the message passing operations and the corresponding intermediate data for backpropagation. DTDGs present an even more challenging scenario where the computation dependencies span across multiple graph snapshots.

In exemplary embodiments, the node dependencies within a snapshot are removed during the training step to reduce the training memory footprint by avoiding involving the k-hop neighbors in the forward and backward pass, and to simplify construction of mini-batches with the full neighborhood information without having to perform any graph traversal and/or neighborhood sampling during training. For example, Let [symbol] ^{t}^{ᵢ}={ [symbol] ₀^{t}^{ᵢ}, . . . , [symbol] ₖ^{t}^{ᵢ}} be a set of linear diffusion operators, χ^{t}^{ᵢ} be the initial node feature matrix and Θ_{f}^{t}^{ᵢ}={Θ_{f}_{₀}^{t}^{ᵢ}, . . . , Θ_{f}_{ₖ}^{t}^{ᵢ}} be a set of learnable matrices for the graph snapshot at time tᵢ. The node embedding matrix [symbol] ^{t}^{ᵢ} for the snapshot at tᵢ is computed as:

$${𝒵}^{{t}_{i}} = ξ ( σ ( {{⊕}_{j = 0}}^{k} {𝒜}_{j}^{{t}_{i}} {𝒳}^{{t}_{i}} {Θ}_{{f}_{j}}^{{t}_{i}} ) {Θ}_{o} )$$

where ξ, σ are non-linearities, Θ₀ is a learnable matrix shared across the time, k is the number of hops, and ⊖ denotes a concatenation operation. The computation of the matrix product [symbol] ⱼ^{t}^{ᵢ}χ^{t}^{ᵢ} does not involve any model parameters, and therefore can be pre-computed prior to the training step which is refer to herein as parameter-free message passing. In exemplary embodiments, the choice of the diffusion operators depends on the task, graph structure and the input features. In exemplary embodiments, the operators may be [symbol] ⱼ= [symbol] ^{j} where [symbol] is a normalized adjacency matrix constructed from an edge set ε. A normalized adjacency matrix can be constructed without much computational cost, and it demonstrates reasonable performance in the static graph setting as compared to other alternatives such as Personalized PageRank-based adjacency and triangle-based adjacency matrices. The higher the power, the further the neighbors an operator aggregates from, which is similar to having a deeper GCN architecture to cover larger neighborhoods. As opposed to the neighborhood sampling idea, such diffusion operations use the complete neighborhood during aggregation.

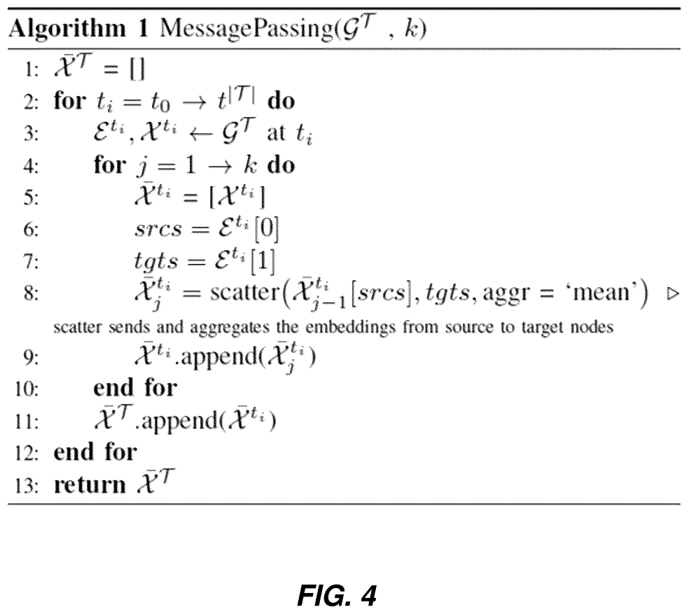

Algorithm 1 shown in FIG. 4, illustrates an example of the parameter-free message passing process using a set of simple diffusion operations. Algorithm 1 performs similarly as stacking multiple GCN layers, however, without any trainable parameters for message encoding, aggregation and updating. Moreover, this process only has to be executed once prior to the beginning of training and/or when a new graph snapshot is available. Algorithm 1 defines a message passing process for the DTDGs. Algorithm 1 iterates over the graph snapshots (line 2-12) and performs k-hop message passing (line 4-10). The aggregation starts with the initial node feature matrix. A node embedding is iteratively updated with its neighbors' embeddings aggregated by a mean pooling operation (line 8). In Algorithm 1, χ̅ⱼ^{t}^{ᵢ} denotes the j-hop node embeddings for the graph snapshot at tᵢ and [symbol] stores all the embeddings of different power for different timestamps (all [symbol] ⱼ^{t}^{ᵢ}χ^{t}^{ᵢ}). χ̅ⱼ^{t}^{ᵢ} can be incrementally generated from χ̅ⱼ^{t}^{ᵢ}⁻¹ by processing the delta information (e.g. insertion and deletion) to only update the affected node embeddings from the previous snapshot. The results of different aggregations are then transformed by the respective Θ_{f}_{ⱼ}^{t}^{ᵢ}. The same set of graph filters is applied on different snapshots independently using the adjacency matrices constructed with the respective edge set. However, moving from snapshot to snapshot, the same graph filter has different parameters adapting to the graph changes over time.

In exemplary embodiments, since the edge information is only used during the diffusion process, there is no node dependency within a graph snapshot that needs to be considered during training, which substantially reduces the memory and compute requirements. Because the memory footprint increases linearly with the number of filters and is independent to the power of the filter, it is easier to include more filters to increase the model capacity with reasonable resource usage.

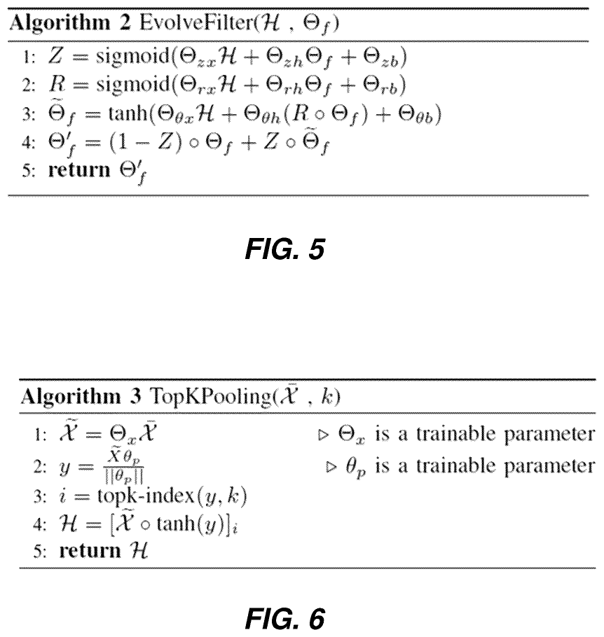

Often the graph filters that fit a snapshot may not still be effective for a new snapshot with many graph changes such as edge deletions, insertions and node updates. Accordingly, in exemplary embodiments, a RNNs is used to regulate the weight matrix in the graph filters over time. In one embodiment, a GRU is used to evolve the graph filter parameters Θ_{f} over time as illustrated by Algorithm 2 shown in FIG. 5.

In Algorithm 2, all the Θ_{S} above except for the Θ_{f} are the trainable parameters of the GRU cell. In exemplary embodiments, the weight matrix from tᵢ₋₁ is updated based on both future and historical information. Algorithm 2 treats the weight matrix Θ_{f}, interpreted as a set of coefficient vectors, as a set of hidden states of a GRU cell. The future information is represented by a succinct graph summary [symbol] for the snapshot at time tᵢ, which has the same dimension as the dimension of Θ_{f}.

In exemplary embodiments, top-k pooling is used to obtain a set of embeddings of representative nodes corresponding to the respective diffusion operation. FIG. 6 illustrates a top-k pooling Algorithm (Algorithm 3) in accordance with an embodiment. In Algorithm 3, the hyper-parameter k for top-k pooling (which may be different from the k in k-hop neighbors) equals the number of coefficient vectors of the to-be-evolved weight matrix Θ_{f}. χ̅= [symbol] χX is the result of a diffusion operation defined by a filter. To increase the model variance, an additional weight matrix Θₓ is added to transform the input embedding matrix. The proposed top-k pooling function creates some dependencies between the nodes since nodes within a graph snapshot need to be scored and ranked. One can carefully sample a subset of the nodes as the candidates for the pooling function when constructing the mini-batches. The selection can be made, for example, by considering the nodes which contribute to the most graph changes from the previous snapshot. Note that each graph filter has an independent GRU and top-k pooling module for evolving its parameters, i.e. the weight matrix of each filter is evolved differently.

In exemplary embodiments, a sequence of node embeddings from the graph snapshots over time can be generated using the evolving filters. To capture the temporal evolutionary patterns of the node embeddings in DTDGs, a self-attention mechanism is used to learn the final node representations for the future graph snapshot.

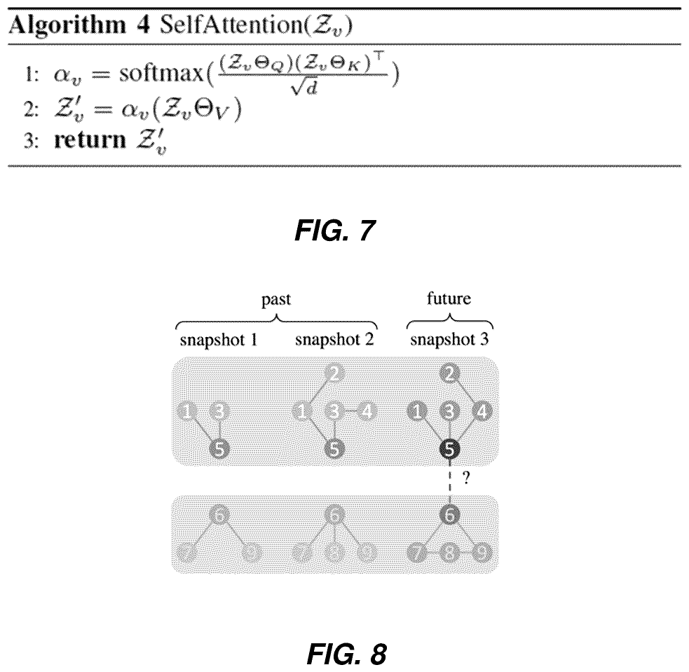

First, a positional encoder is used to obtain a sequence of positional embeddings [symbol] ={pₜ_{₀}, . . . , [symbol] } corresponding to [symbol] . Such a positional embedding describes the location or position of a node embedding in the time sequence [symbol] so that each position is assigned a unique representation. In one embodiment, the relative temporal order of the snapshots are considered. In another embodiment, the absolute timestamp of the snapshots are considered using a functional time encoder. Let [symbol] ₚ={zᵥ^{t}^{₀}+pₜ_{₀}, . . . , [symbol] + [symbol] } be the concatenated node and positional embeddings for node v throughout the snapshots, where zᵥ^{t}^{ₖ} is the node embedding vector of v from the snapshot at tₖ. A new sequence using the self-attention mechanism can be obtained using Algorithm 4, shown in FIG. 7. In Algorithm 4, Θ_{Q}, Θ_{K} and Θ_{V} are trainable parameters and d is the dimension of zᵥ^{t}^{ₖ}. The task is defined as predicting the future based on the past, meaning that the information flows in one direction with the future having access to the past but not vice versa. To prevent leftward information flow (i.e., past accessing the future) to preserve the auto-regressive property, all the values in the input to SoftMax that correspond to these illegal connections are masked. The last embedding in the sequence is then used as the final node embedding of node v for the prediction task.

In exemplary embodiments, a link prediction task for a DTDG is used to predict the missing links in a future snapshot, as illustrated in FIG. 8. Given two node embeddings generated, a decoder predicts whether or not there should exist a link between the two nodes. Let y be the ground truth, indicating whether or not two nodes are linked in the data, the training objective is to maximize the likelihood of the conditional probability p (y|g_{θ}(vᵢ), g_{θ}(vⱼ)) where g_{Θ} is the function that maps a node to a lower dimensional space.

For training, part of the observed edges in the future snapshot are leveraged as positive samples, and the rest of the observed edges in the same snapshot are used for message passing/diffusion. All the unobserved edges in that snapshot are negative samples. Instead of using all the unobserved edges in one training epoch, negative sampling is used, where a subsample is obtained by corrupting a positive sample.

The model weights Θ are optimized by minimizing the following negative likelihood for both positive and negative edges:

$$ℒ = - {\sum }_{( {v}_{i} , {v}_{j} ) ∈ {ε}^{{t}_{k}}} log ( σ ( {g}_{Θ} ( {v}_{i} ) {Tg}_{Θ} ( {v}_{j} ) ) ) - {\sum }_{( {v}_{m} , {v}_{n} ) ∉ {ε}^{{t}_{k}}} log ( σ ( {g}_{Θ} ( {v}_{m} ) {Tg}_{Θ} ( {v}_{n} ) ) ) ,$$

where σ is the sigmoid function. The link prediction decoder performs the dot-product multiplication between two node embeddings followed by σ. A full list of model parameters Θ as well as their dimensionality and descriptions are provided in Table 2 below.

TABLE II
I IS THE DEMENSION OF THE INITIAL FEATURE VECTOR.
d IS THE DIMENSION OF THE OUTPUPT EMBEDDING.
k IS THE NUMBER OF HOPS. M IS THE INPUT DIMENSION
TO THE SELF-ATTENTION NETWORK.

| Parameter | Dimension | Description |
|---|---|---|
| Θ_{fj}_{^{ti}} | I × d | The j^{th} graph filter’s node-wise |
| | | transformation weight matrix at time tᵢ. |
| Θ_{O} | (k + 1)d × d | The weight matrix that reduces the concatenated graph filter results. |
| Θₓ | I × I | The weight matrix in the top-k pooling |
| | | that transforms the initial node vector. |
| θp | I × I | The coefficient vector in the top-k pooling that scores the node vector. |
| Θ_{zx} | I × I | The update gate weight matric that transforms the inputs. |
| Θₓₕ | I × I | The update gate weight matrix that transforms the hidden states. |
| Θ_{xb} | I × d | The bias for the update gate. |
| Θᵣₓ | I × I | The reset gate weight matrix that transforms the inputs. |
| Θᵣₕ | I × I | The reset gate weight matrix that transforms the hidden states. |
| Θ_{rb} | I × d | The bias for the reset gate. |
| Θ_{θx} | I × I | The candidate cell weight matrix that transforms the input. |
| Θ_{θh} | I × I | The candidate cell weight matrix that transforms the hidden states. |
| Θ_{θb} | I × d | The bias for the candidate cell. |
| Θ_{V} | M × d | The weight matrix that transforms the valve. |
| Θ_{Q} | M × d | The weight matrix that transforms the queries. |
| Θ_{K} | M × d | The weight matrix that transforms the keys. |

In exemplary embodiments, a mini batch is constructed by partitioning the node set. Each mini batch contains the data relevant to the entire lifespan of the contained nodes. For methods that perform parameterized message passing and node embedding evolving, all the k-hop neighbors of the embedded node within the future and the past snapshots, as illustrated in FIG. 8, have to be included for the forward and backward passes. On the other hand, during training, access to the actual k-hop neighbors of the contained nodes as the message passing is not needed, as it was already done prior to the model training in the preprocessing step.

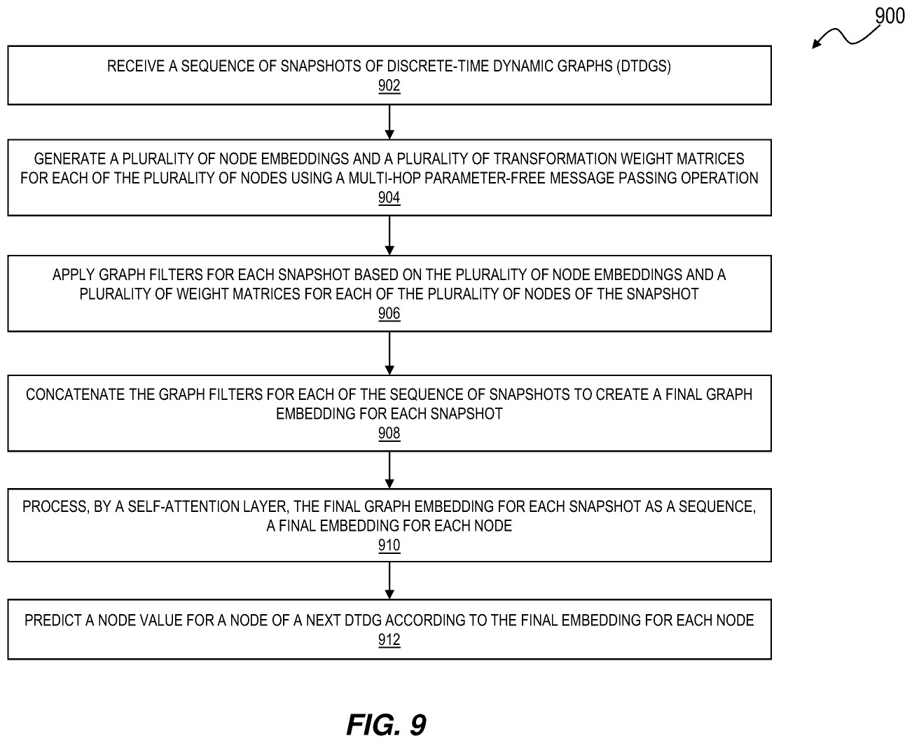

Referring now to FIG. 9, a flowchart of a method 900 for providing a schema evolution on a live database system without an outage is generally shown according to an embodiment. Although depicted in a particular order, the blocks depicted in FIG. 9 can be rearranged, subdivided, and/or combined. In exemplary embodiments, the method 900 can be performed by a comping environment 100 shown in FIG. 1.

The method 900 begins at block 902 by receiving a sequence of snapshots of discrete-time dynamic graphs (DTDGs), each snapshot including plurality of nodes. Next as shown at block 904, the method 900 includes generating a plurality of node embeddings and a plurality of transformation weight matrices for each of the plurality of nodes using a multi-hop parameter-free message passing operation. In exemplary embodiments, each node embedding is generated using a diffusion operation followed by a node-wise transformation. In one embodiment, the diffusion operation, is a k-hop message passing operation without any trainable parameters. In exemplary embodiments, top-k pooling is used to obtain a set of embeddings of representative nodes for each snapshot corresponding to the respective diffusion operation.

As shown at block 906, the method 900 includes applying graph filters for each snapshot based on the plurality of node embeddings and a plurality of weight matrices for each of the plurality of nodes of the snapshot. In exemplary embodiments, a recurrent neural network is used to regulate the plurality of weight matrices in the graph filters over time. In one embodiment, the recurrent neural network is a gated recurrent unit that receives a previous weight matrix as a hidden state and a graph summary as inputs, and outputs the weight matrix which is used for generating the embeddings for each snapshot.

Next, as shown at block 908, the method 900 includes concatenating the graph filters for each of the sequence of snapshots to create a final graph embedding for each snapshot. The method 900 further includes processing, by a self-attention layer, the final graph embedding for each snapshot as a sequence, a final embedding for each node. In exemplary embodiments, the self-attention layer masks data from subsequent snapshots during processing of earlier snapshots. The method 900 concludes at block 912 by predicting a node value for a node of a next DTDG according to the final embedding for each node.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for predicting system behaviors using a trained machine learning model, the method comprising:
receiving a sequence of snapshots of discrete-time dynamic graphs (DTDGs), each snapshot including a plurality of nodes;
generating a plurality of node embeddings and a plurality of transformation weight matrices for each of the plurality of nodes using a multi-hop parameter-free message passing operation;
applying graph filters for each snapshot based on the plurality of node embeddings and a plurality of weight matrices for each of the plurality of nodes of the snapshot;
concatenating the graph filters for each of the sequence of snapshots to create a final graph embedding for each snapshot;
processing, by a self-attention layer, the final graph embedding for each snapshot as a sequence, a final embedding for each node; and
predicting a node value for a node of a next DTDG according to the final embedding for each node.

2. The computer-implemented method of claim 1, wherein each node embedding is generated using a diffusion operation followed by a node-wise transformation.

3. The computer-implemented method of claim 2, wherein the diffusion operation, is a k-hop message passing operation without any trainable parameters.

4. The computer-implemented method of claim 1, wherein a recurrent neural network is used to regulate the plurality of weight matrices in the graph filters over time.

5. The computer-implemented method of claim 4, wherein the recurrent neural network is a gated recurrent unit that receives a previous weight matrix as a hidden state and a graph summary as inputs, and outputs the weight matrix which is used for generating the embeddings for each snapshot.

6. The computer-implemented method of claim 2, wherein top-k pooling is used to obtain a set of embeddings of representative nodes for each snapshot corresponding to the respective diffusion operation.

7. The computer-implemented method of claim 1, wherein the self-attention layer masks data from subsequent snapshots during processing of earlier snapshots.

8. A system having a memory, computer readable instructions, and one or more processors for executing the computer readable instructions, the computer readable instructions controlling the one or more processors to perform operations comprising:
receiving a sequence of snapshots of discrete-time dynamic graphs (DTDGs), each snapshot including a plurality of nodes;
generating a plurality of node embeddings and a plurality of transformation weight matrices for each of the plurality of nodes using a multi-hop parameter-free message passing operation;
applying graph filters for each snapshot based on the plurality of node embeddings and a plurality of weight matrices for each of the plurality of nodes of the snapshot;
concatenating the graph filters for each of the sequence of snapshots to create a final graph embedding for each snapshot;
processing, by a self-attention layer, the final graph embedding for each snapshot as a sequence, a final embedding for each node; and
predicting a node value for a node of a next DTDG according to the final embedding for each node.

9. The system of claim 8, wherein each node embedding is generated using a diffusion operation followed by a node-wise transformation.

10. The system of claim 9, wherein the diffusion operation, is a k-hop message passing operation without any trainable parameters.

11. The system of claim 8, wherein a recurrent neural network is used to regulate the plurality of weight matrices in the graph filters over time.

12. The system of claim 11, wherein the recurrent neural network is a gated recurrent unit that receives a previous weight matrix as a hidden state and a graph summary as inputs, and outputs the weight matrix which is used for generating the embeddings for each snapshot.

13. The system of claim 9, wherein top-k pooling is used to obtain a set of embeddings of representative nodes for each snapshot corresponding to the respective diffusion operation.

14. The system of claim 8, wherein the self-attention layer masks data from subsequent snapshots during processing of earlier snapshots.

15. A computer program product comprising a computer readable storage medium having program instructions embodied therewith, the program instructions executable by one or more processors to cause the one or more processors to perform operations comprising:
receiving a sequence of snapshots of discrete-time dynamic graphs (DTDGs), each snapshot including a plurality of nodes;
generating a plurality of node embeddings and a plurality of transformation weight matrices for each of the plurality of nodes using a multi-hop parameter-free message passing operation;
applying graph filters for each snapshot based on the plurality of node embeddings and a plurality of weight matrices for each of the plurality of nodes of the snapshot;
concatenating the graph filters for each of the sequence of snapshots to create a final graph embedding for each snapshot;
processing, by a self-attention layer, the final graph embedding for each snapshot as a sequence, a final embedding for each node; and
predicting a node value for a node of a next DTDG according to the final embedding for each node.

16. The computer program product of claim 15, wherein each node embedding is generated using a diffusion operation followed by a node-wise transformation.

17. The computer program product of claim 16, wherein the diffusion operation, is a k-hop message passing operation without any trainable parameters.

18. The computer program product of claim 15, wherein a recurrent neural network is used to regulate the plurality of weight matrices in the graph filters over time.

19. The computer program product of claim 18, wherein the recurrent neural network is a gated recurrent unit that receives a previous weight matrix as a hidden state and a graph summary as inputs, and outputs the weight matrix which is used for generating the embeddings for each snapshot.

20. The computer program product of claim 15, wherein top-k pooling is used to obtain a set of embeddings of representative nodes for each snapshot corresponding to the respective diffusion operation.
